(19) United States
(12) Patent Application Publication
(10) Pub. No.: US 2018/0062544 A1
(43) Pub. Date: Mar. 1, 2018

(54) MOTOR STARTERS USING PULSE SEQUENCES WITH SUBFUNDAMENTAL MODULATION

(71) Applicant: Eaton Corporation, Cleveland, OH (US)

(72) Inventors: Kevin Lee Vaneyll, Foster City, CA (US); Benjamin Stewart Wells, Arden, NC (US); Geraldo Nojima, Matthews, NC (US)

(21) Appl. No.: 15/254,729

(22) Filed: Sep. 1, 2016

(51) Int. Cl. H02P 1/04; H02P 1/16

(52) U.S. Cl. CPC H02P 1/04; H02P 1/16

(57) ABSTRACT

A motor starter includes a first switch configured to couple and decouple an AC power source to a motor, a second switch configured to bypass the first switch, and a control circuit configured to operate the first switch to modulate an AC voltage applied to the motor from the AC power source at a frequency that is less than a fundamental frequency of the AC voltage and to operate the second switch to bypass the first switch responsive to operation of the motor meeting a predetermined criterion.

### BACKGROUND

The inventive subject matter relates to motor drives and, more particularly, to soft starters for motors.

Motor starters are commonly used with industrial electric motors. Typical solid-state motor starters control starting characteristics to meet application requirements, including acceleration and deceleration time, starting current and motor torque. Soft starters are commonly used to limit inrush current when the motor is first coupled to a power source, as large inrush currents may cause voltage dips that may negatively affect other loads coupled to the same source. Starters may also limit starting torque, as high starting torque may cause electromechanical shock that can damage windings and other components of the motor, as well as drive trains and other components mechanically coupled to the motor.

A reduced-voltage soft starter (RVSS) may use silicon-controlled rectifiers (SCRs) that are connected in series between an AC power source and the load. The SCRs may be phase controlled to apply a reduced RMS voltage to the motor during startup. Typically, the RMS voltage is ramped up to the normal operating RMS voltage at a preset rate using a series of pulses at the fundamental frequency of the AC power source. This may reduce the starting current at the expense of reduced starting torque, and thus limit the types of applications in which RVSSs may be used effectively. For example, applications that require high starting torque, such as motors driving conveyers or industrial equipment such as mixers, grinders or crushers, may have high starting torque requirements that cannot be met using a conventional RVSS. Such loads may require the use of a larger and costlier variable frequency drive (VFD).

### SUMMARY

Some embodiments of the inventive subject matter provide methods of starting a motor. The methods include operating a switch configured to couple an AC power source to the motor to modulate an AC voltage applied to the motor from the AC power source at a frequency that is less than a fundamental frequency of the AC voltage and bypassing the switch to couple the AC power source to the motor responsive to operation of the motor meeting a predetermined criterion. In some embodiments, operating a switch configured to couple an AC power source to the motor to modulate an AC voltage applied to the motor from the AC power source at a frequency that is less than a fundamental frequency of the AC voltage may include operating the switch to modulate an AC voltage applied to the motor from the AC power source at a frequency that is a subharmonic of the fundamental frequency. In some embodiments, operating a switch configured to couple an AC power source to the motor to modulate an AC voltage applied to the motor from the AC power source at a frequency that is less than a fundamental frequency of the AC voltage may include operating the switch to apply a voltage of a first polarity in a first half of a modulation cycle and to apply a voltage of a second polarity in a second half of a modulation cycle. Operating a switch configured to couple an AC power source to the motor to modulate an AC voltage applied to the motor from the AC power source at a frequency that is less than a fundamental frequency of the AC voltage may include providing a series of pulses of the AC voltage occurring at the fundamental frequency and having varying pulse durations.

In some embodiments, operating a switch configured to couple an AC power source to the motor to modulate an AC voltage applied to the motor from the AC power source at a frequency that is less than a fundamental frequency of the AC voltage may include modulating the AC voltage at a first frequency and modulating the AC voltage at a second frequency greater than the first frequency and less than the fundamental frequency. Modulating the AC voltage at a second frequency greater than the first frequency and less than the fundamental frequency may include changing from modulating at the first frequency to modulating at the second frequency responsive to meeting a predetermined criterion. The methods may further include sensing a speed of the motor using a speed sensor and/or back electromotive force (EMF) and changing from modulating at the first frequency to modulating at the second frequency responsive to meeting a predetermined criterion may include changing from modulating at the first frequency to modulating at the second frequency responsive to the sensed speed meeting a predetermined criterion. Modulating at the second frequency may apply a greater RMS voltage to the motor than modulating at the first frequency. The first and second frequencies may be subharmonics of the fundamental frequency.

Further embodiments of the inventive subject matter may provide a motor starter including a first switch configured to couple and decouple an AC power source to and from a motor, a second switch configured to bypass the first switch, and a control circuit configured to operate the first switch to modulate an AC voltage applied to the motor from the AC power source at a frequency that is less than a fundamental frequency of the AC voltage and to operate the second switch to bypass the first switch responsive to operation of the motor meeting a predetermined criterion.

### BRIEF DESCRIPTION OF THE DRAWINGS

FIG. 1 is a schematic diagram illustrating a motor starter apparatus according to some embodiments.

FIG. 2 is a waveform diagram illustrating a pulse sequence of the motor starter apparatus of the FIG. 2 according to some embodiments.

FIG. 3 is waveform diagram illustrating a current produced by the pulse sequence of FIG. 3.

FIG. 4 is a flowchart illustrating motor start operations according to some embodiments.

FIG. 5 is a flowchart illustrating motor start operations according to further embodiments.

FIG. 6 is a flowchart illustrating motor deceleration operations according to further embodiments.

### DETAILED DESCRIPTION

Specific exemplary embodiments of the inventive subject matter now will be described with reference to the accompanying drawings. This inventive subject matter may, however, be embodied in many different forms and should not be construed as limited to the embodiments set forth herein; rather, these embodiments are provided so that this disclosure will be thorough and complete, and will fully convey the scope of the inventive subject matter to those skilled in the art. In the drawings, like numbers refer to like items. It will be understood that when an item is referred to as being “connected” or “coupled” to another item, it can be directly connected or coupled to the other item or intervening items may be present. As used herein the term “and/or” includes any and all combinations of one or more of the associated listed items.

The terminology used herein is for the purpose of describing particular embodiments only and is not intended to be limiting of the inventive subject matter. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, items, and/or components, but do not preclude the presence or addition of one or more other features, integers, steps, operations, items, components, and/or groups thereof.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the specification and the relevant art and will not be interpreted in an idealized or overly formal sense unless expressly so defined herein.

Conventional RVSSs use solid-state switches to sweep across an AC voltage source sine wave from its zero crossings to increase the motor voltage from zero to a rated value, thus developing a voltage output having the same dominant or fundamental frequency as the AC voltage source. In contrast, in some embodiments of the inventive subject matter, RVSS switches are used to control not only the motor voltage but also the dominant or fundamental frequency applied to the motor by pulse-width modulating the AC source voltage using the AC source frequency as the switching frequency. By turning-on the SCR bidirectional switches at the correct angles, an output voltage is produced having a dominant or fundamental component that is a subharmonic of the AC source fundamental frequency, which is filtered by the motor inductance and generate a current that can generate increased motor torque at lower speeds. Thus, a reduced voltage soft starter (RVSS) may be used to mimic a constant volts-per-Hertz (V/Hz) ramp using a combination of subharmonic pulse-width modulation sequences and phase gating control to control RMS voltage. The RVSS may ramp up the RMS voltage and the pulse-width modulation frequency through a series of steps to accelerate the motor sufficiently and allow transfer to the AC source. In some embodiments, an RVSS can pulse-width modulate the AC voltage at a frequency that is a subharmonic of the line frequency by selectively gating selected ones of pairs of antiparallel-connected SCRs to provided selected polarity and pulse width patterns.

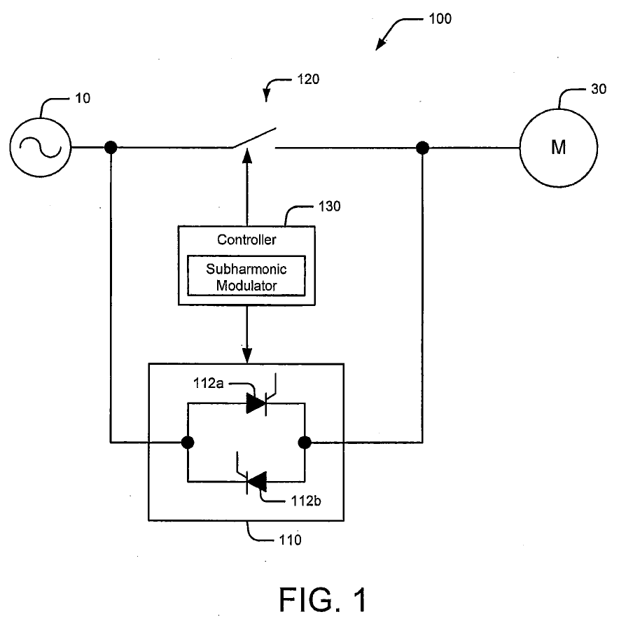

FIG. 1 illustrates a motor starter apparatus 100 according to some embodiments of the inventive subject matter. The apparatus 100 includes a first switch 110 configured to couple and decouple an AC power source 10 to and from a motor 30. As shown, the first switch 110 is a selectively rectifying switch that includes anti-parallel connected silicon controlled rectifiers (SCRs) 112a, 112b which are configured to allow current flow in opposing directions, but it will be appreciated that other arrangements of switching devices (e.g., transistors) may be used in other embodiments. The apparatus 100 further includes a second switch 120, which is configured to bypass the first switch 110 and directly couple the AC power source 10 to the motor 30. It will be appreciated that the second switch 120 may be implemented using any of a number of different types of electromechanical and/or solid-state switches

A controller 130 is configured to control the first switch 110 and the second switch 120. The controller 130 may be configured to implement a sub-fundamental modulator 132 that causes the controller 130 to operate the solid-state first switch 110 to apply a pulse-width modulation to an AC voltage produced by the AC power source 10 at a frequency that is lower (e.g., a subharmonic) of a fundamental frequency of the AC voltage produced by the AC power source 10 to accelerate the motor 30. As explained below, according to some embodiments, such sub-fundamental modulation may be applied at a succession of increasing modulation frequencies to accelerate the motor 30 to a point at which the second switch 120 can be closed to operate the motor 30 directly from the AC power source 10. Similarly, a decreasing series of modulation frequencies may be used to decelerate the motor 30. It will be appreciated that controller 130 may be implemented using any of a variety of different analog and/or digital circuitry, including, for example, data processing devices, such as microcontrollers, and associated peripheral circuitry for controlling the first switch 110 and the second switch 120, and for interfacing with various sensors (e.g., current, speed and voltage sensors) that may be used to monitor the AC power source 10, the motor 30 and other system components.

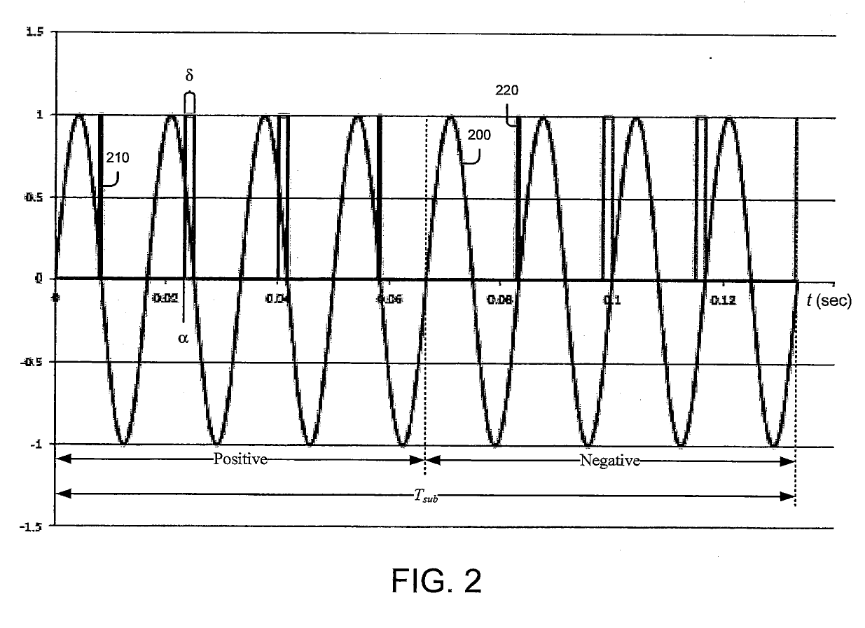

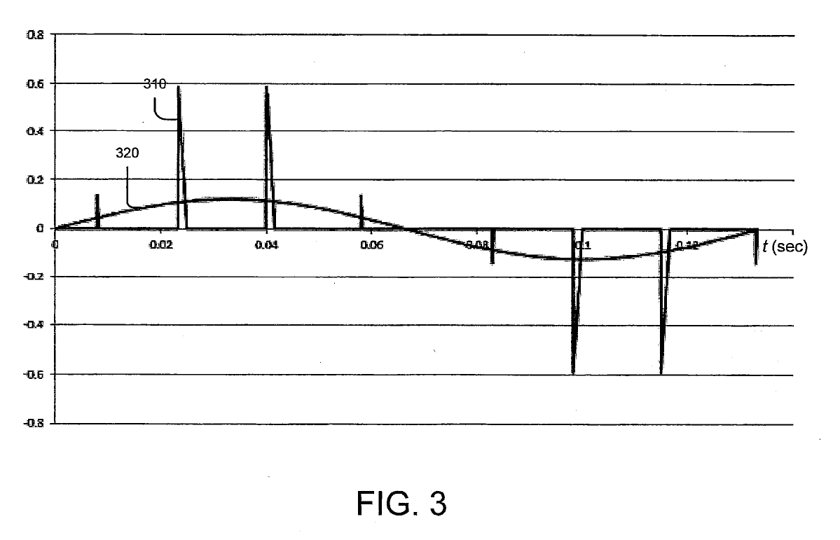

FIG. 2 is a waveform diagram illustrating an example of a pulse sequence produced by such modulation according to some embodiments. In the illustrated example, the pulses of the pulse sequence are output at a 60 Hz fundamental frequency, but the polarity of the pulses varies at a subharmonic frequency of 7.5 Hz, i.e., one-eighth of the 60 Hz AC voltage 200 of the AC power source. In a “positive” half cycle 210 the first SCR 112a is gated in positive half cycles of the AC voltage 210. In a “negative” half cycle 220 the second SCR 112b is gated in negative half cycles of the AC voltage 200. As further shown, durations δ of the pulses vary in a pattern over the modulation cycled period T_{sub} to control the RMS voltage applied to the motor. FIG. 3 illustrates a current output 310 produced by such modulation in relation to a 7.5 Hz reference waveform 320. Referring again to FIG. 1, a line reactor (not shown) could be introduced between the first switch 110 and the motor 30 to filter out some of the 60 Hz component and reduce peak current, but this may not be needed for purposes of starting the motor 30.

According to further aspects, modulation of the form shown in FIG. 2 may be applied to a motor at successively greater subharmonic frequencies to accelerate a motor. For each of these subharmonic modulation frequencies, a desired pulse duration pattern (e.g., the pattern of pulse durations δ shown in FIG. 2) may be selected to achieve a desired RMS voltage for the given step. Transitions between these steps in subharmonic modulation frequency may be based on a predetermined criterion, such as lapse of a predetermined time interval.

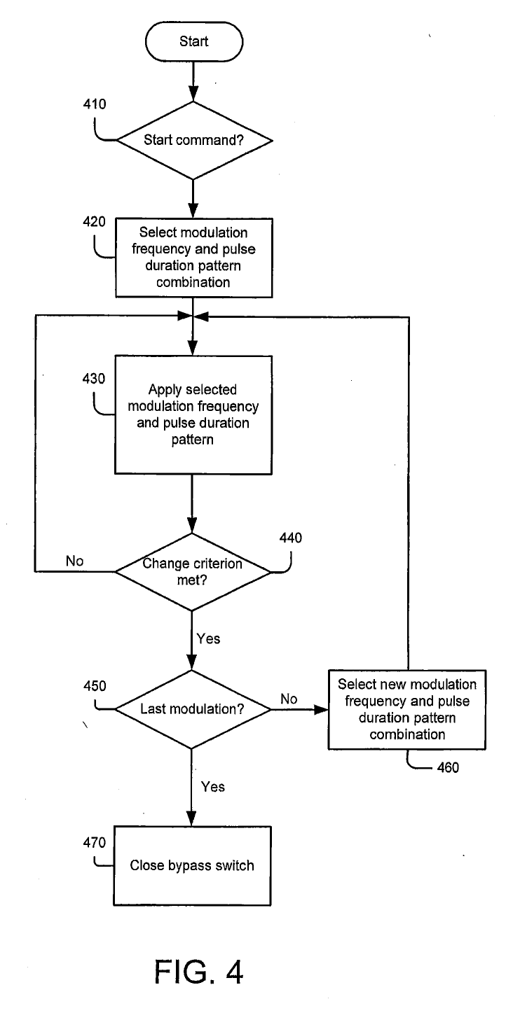

FIG. 4 illustrates such a technique according to some embodiments. Referring to FIGS. 1 and 4, upon assertion of a start command (e.g., a user input), an initial combination of a modulation frequency and pulse duration pattern is selected (blocks 410, 420). The first switch 110 is operated to apply the selected combination of modulation frequency and pulse duration pattern to the AC voltage produced by the AC source 10 (block 430). If a predetermined criterion is met and a last modulation has not been reached (blocks 440, 450), a new combination of modulation frequency and pulse duration pattern is selected and applied (blocks 460, 430). As noted above, the new combination of modulation frequency and pulse duration pattern may be selected to provide a substantially constant volts-per-Hertz (V/Hz) ramp. The predetermined criterion for changing the modulation may be, for example, lapse of a predetermined time interval using the current modulation. If no further modulation steps remain, the second switch 120 is closed to bypass the first switch 110 and allow the motor to operate directly from the AC source 10 (block 470). It will be appreciated that one or more of the last modulation steps may include subharmonic frequency modulations as described above, or modulations that apply a modulation frequency the same as the fundamental frequency of the voltage of the AC source 10.

The pulse patterns may be generated in any of a number of different ways. For example, in embodiments using a microcontroller or other data processing device for controlling the modulation switch, the pulse duration may be determined from one or more lookup tables that associate pulse width with a phase of the modulation cycle in patterns that define one or more fundamental frequencies which are less than the AC source fundamental frequency. These patterns are swept by the controller, going up or down in fundamental frequency to accelerate or decelerate the motor. Other embodiments may use functionally similar analog circuitry. For example, a pulse width modulator may operate based on comparison of a saw tooth waveform to a reference sine wave signal that has a frequency corresponding to the desired subharmonic and an amplitude that controls pulse duration. Accordingly, selection of a modulation frequency and pulse duration pattern may include, for example, selection of entries in a lookup table or adjustment of a reference signal.

The modulation frequencies and pulse duration patterns used may be based, for example, on the nature of the load. Modulation frequencies and pulse duration patterns may be selected based on a priori knowledge of the motor characteristics and the load requirements and/or may be adaptively selected or modified based on performance feedback. For example, modulation frequencies and pulse duration patterns may be adjusted based on measurements of motor parameters (e.g., speed, current) and/or other parameters as the starter is operated, thus enabling optimization of starter operations.

It will be appreciated that the operations shown in FIG. 4 may be varied. For example, at any given modulation frequency, multiple different pulse duration patterns may be successively applied, such that the voltage provided by the starter may be varied for the given modulation frequency. For example, a first subharmonic modulation frequency may be used with first series of pulse duration patterns, a second subharmonic modulation frequency may be used with a second series of pulse duration patterns, and so on, resulting in respective voltage ramps for respective ones of the modulation frequencies. In further embodiments, a series of subfundamental frequency modulation steps along the lines described above may be used to initially accelerate the motor up to a point that a more conventional voltage ramp at the fundamental frequency of the AC source may be used to accelerate the motor to the desired final speed.

According to further embodiments, transitions between modulation frequencies may be conditioned upon the motor reaching a predetermined state. For example, the speed of the motor may be detected from a speed sensor (e.g., a Hall effect sensor or optical encoder) or back emf and, when the speed indicates that the motor is no longer sufficiently accelerating, the next higher subharmonic modulation frequency and associated pulse duration pattern may be selected. When the last modulation frequency is reached and the motor is no longer accelerating, the bypass switch (e.g., the second switch 120 of FIG. 1) may be closed to couple the motor to the AC power source through a lower-loss path.

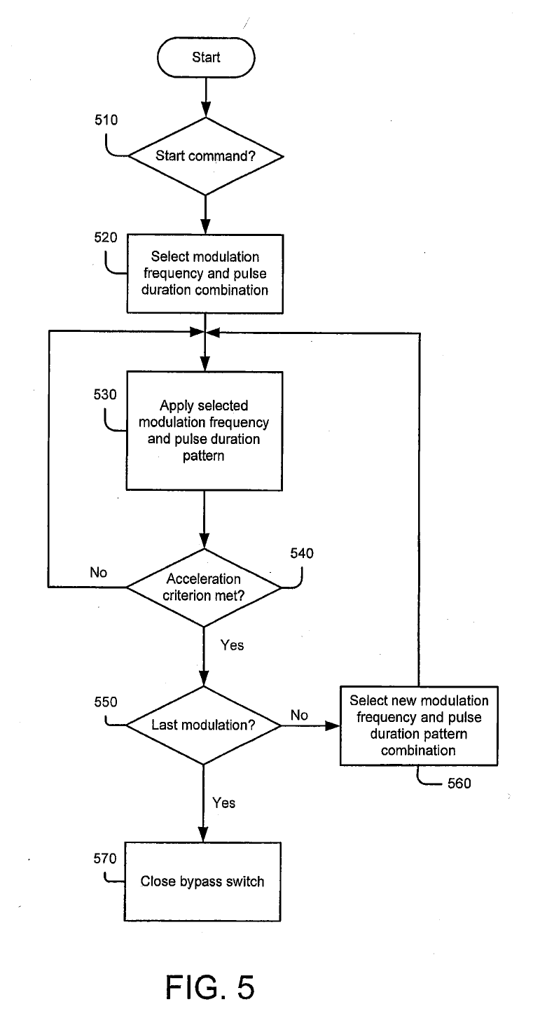

FIG. 5 illustrates such a technique according to some embodiments. Referring to FIGS. 1 and 5, upon assertion of a start command (e.g., a user input), an initial combination of modulation frequency and pulse duration pattern is selected (blocks 510, 520). The first switch 110 is operated using to apply the selected modulation frequency and pulse duration pattern (block 530). If a speed of the motor meets an acceleration criterion (e.g., if the speed indicates that the motor is no longer sufficiently accelerating) and a last modulation step has not been reached (blocks 540, 550), a new combination of modulation frequency and pulse duration pattern is selected and applied (blocks 560, 530). If the acceleration criterion has been satisfied and no further modulation steps remain, the second switch 120 is closed to bypass the first switch 110 and allow the motor to operate from the AC source 10 through a lower loss path (block 570).

It will be appreciated that further embodiments may variations on the criteria for changing modulations described above with reference to FIGS. 4 and 5. For example, in some embodiments, transitions between pulse sequences may be conditioned upon a combination of time and speed criteria described above with reference to FIGS. 4 and 5 and/or upon other criteria.

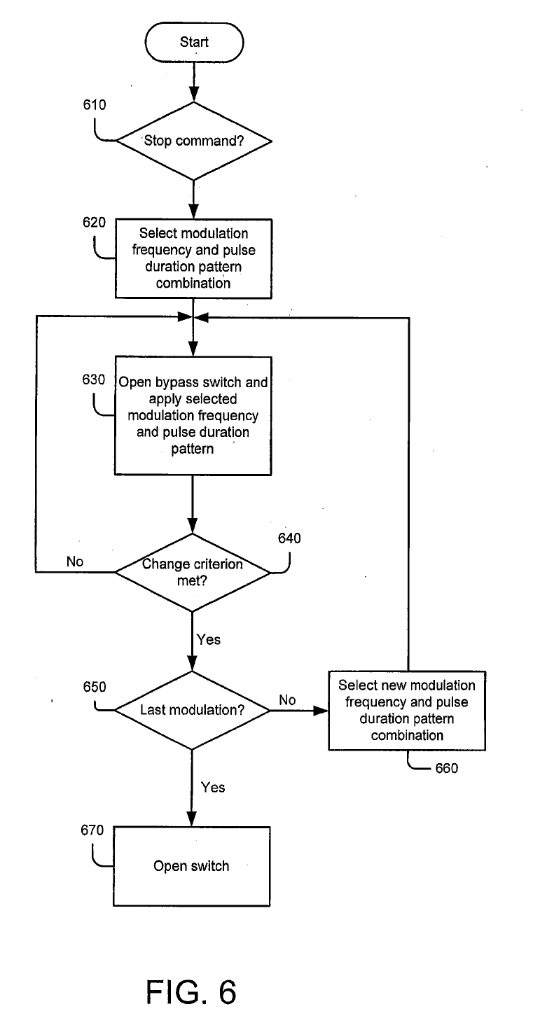

According to further embodiments, similar operations may be used for decelerating a motor. Referring to FIGS. 1 and 6, upon assertion of a stop command (e.g., a user input), a combination of modulation frequency and pulse duration is selected (blocks 610, 620). The second (bypass) switch 120 is opened and the first switch 110 operated to apply a selected modulation frequency and pulse duration pattern (block 630). The initial modulation may, for example, cause application of a voltage with the same fundamental as the AC power source 10, perhaps with pulse durations that provide a reduced RMS voltage. In some embodiments, the initial modulation may be a subfundamental (e.g., subharmonic) frequency modulation along the lines described above. If a predetermined criterion is met and a last modulation step has not been reached (blocks 640, 650), a new combination of modulation frequency and pulse duration pattern is selected and applied (blocks 660, 630). The predetermined criterion may be, for example, lapse of a predetermined time interval using the selected modulation and/or a predetermined state (e.g., speed) of the motor. If no further modulation steps remain, the first switch 110 is maintained in an open state, thus disconnecting the motor 30 from the AC power source 10 (block 660).

In the drawings and specification, there have been disclosed exemplary embodiments of the inventive subject matter. Although specific terms are employed, they are used in a generic and descriptive sense only and not for purposes of limitation, the scope of the inventive subject matter being defined by the following claims.

That which is claimed:

1. A method of starting a motor, the method comprising:
operating a switch configured to couple an AC power source to the motor to modulate an AC voltage applied to the motor from the AC power source at a frequency that is less than a fundamental frequency of the AC voltage; and
bypassing the switch to couple the AC power source to the motor responsive to operation of the motor meeting a predetermined criterion.

2. The method of claim 1, wherein operating a switch configured to couple an AC power source to the motor to modulate an AC voltage applied to the motor from the AC power source at a frequency that is less than a fundamental frequency of the AC voltage comprises providing a series of pulses of the AC voltage that occur at the fundamental frequency and have varying pulse durations.

3. The method of claim 1, wherein operating a switch configured to couple an AC power source to the motor to modulate an AC voltage applied to the motor from the AC power source at a frequency that is less than a fundamental frequency of the AC voltage comprises:
modulating the AC voltage at a first frequency; and
modulating the AC voltage at a second frequency greater than the first frequency and less than the fundamental frequency.

4. The method of claim 3, wherein modulating the AC voltage at a second frequency greater than the first frequency and less than the fundamental frequency comprises changing from modulating at the first frequency to modulating at the second frequency responsive to meeting a predetermined criterion.

5. The method of claim 4, further comprising sensing a speed of the motor using a speed sensor and/or back electromotive force (EMF) and wherein changing from modulating at the first frequency to modulating at the second frequency responsive to meeting a predetermined criterion comprises changing from modulating at the first frequency to modulating at the second frequency responsive to the sensed speed meeting a predetermined criterion.

6. The method of claim 3, wherein modulating at the second frequency applies a greater RMS voltage to the motor than modulating at the first frequency.

7. The method of claim 3, wherein the first and second frequencies are subharmonics of the fundamental frequency.

8. The method of claim 1, wherein operating a switch configured to couple an AC power source to the motor to modulate an AC voltage applied to the motor from the AC power source at a frequency that is less than a fundamental frequency of the AC voltage comprises operating the switch to modulate an AC voltage applied to the motor from the AC power source at a frequency that is a subharmonic of the fundamental frequency.

9. The method of claim 1, wherein operating a switch configured to couple an AC power source to the motor to modulate an AC voltage applied to the motor from the AC power source at a frequency that is less than a fundamental frequency of the AC voltage comprises operating the switch to apply a voltage of a first polarity in a first half of a modulation cycle and to apply a voltage of a second polarity in a second half of a modulation cycle.

10. A motor starter comprising:
a first switch configured to couple and decouple an AC power source to and from a motor;
a second switch configured to bypass the first switch; and
a control circuit configured to operate the first switch to modulate an AC voltage applied to the motor from the AC power source at a frequency that is less than a fundamental frequency of the AC voltage and to operate the second switch to bypass the first switch responsive to operation of the motor meeting a predetermined criterion.

11. The motor starter of claim 10, wherein the control circuit is configured modulate the AC voltage at the frequency that is less than the fundamental frequency of the AC voltage by providing a series of pulses of the AC voltage that occur at the fundamental frequency and have varying pulse durations.

12. The motor starter of claim 1, wherein the control circuit is configured to modulating the AC voltage at a first frequency and then modulate the AC voltage at a second frequency greater than the first frequency and less than the fundamental frequency.

13. The motor starter of claim 12, wherein the control circuit is configured to change from modulating at the first frequency to modulating at the second frequency responsive to meeting a predetermined criterion.

14. The motor starter of claim 13, wherein the control circuit is configured to sense a speed of the motor using a speed sensor and/or back electromotive force (EMF) and to change from modulating at the first frequency to modulating at the second frequency responsive to the sensed speed meeting a predetermined criterion.

15. The motor starter of claim 12, wherein the modulating at the second frequency applies a greater RMS voltage to the motor than modulating at the first frequency.

16. The motor starter of claim 12, wherein the first and second frequencies are subharmonics of the fundamental frequency.

17. The motor starter of claim 10, wherein the control circuit is configured to modulate the AC voltage at a frequency that is a subharmonic of the fundamental frequency.

18. The motor starter of claim 10, wherein the control circuit is configured to apply a voltage of a first polarity during a first half of a modulation cycle and to apply a voltage of a second polarity during a second half of a modulation cycle.
